(19) United States
(12) Patent Application Publication
(10) Pub. No.: US 2006/0215287 A1
(43) Pub. Date: Sep. 28, 2006

(54) Light-splitting device with one-dimension of movement

(75) Inventor: Li-Teng Keng, Taipei City (TW)

Correspondence Address: BIRCH STEWART KOLASCH & BIRCH, PO BOX 747, FALLS CHURCH, VA, 22040-0747, US

(73) Assignee: PRODISC TECHNOLOGY INC.

(21) Appl. No.: 11/316,736

(22) Filed: Dec. 27, 2005

(30) Foreign Application Priority Data
Mar. 24, 2005 (TW) 094109179

(51) Int. Cl. G02B 5/22

(52) U.S. Cl. 359/891; 359/892

(57) ABSTRACT

A light-splitting device with one-dimension of movement is disposed on a casing. The light-splitting device includes a bearing element, a filter element and a power module. In this case, the bearing element is slidably disposed on the casing. The filter element is a color filter having a plurality of color sections. The filter element is disposed on the bearing element. The power module is connected to the bearing element. The power module drives the bearing element to move in one dimension.

### BACKGROUND OF THE INVENTION

1. Field of Invention

The invention relates to a light-splitting device and, in particular, to a light-splitting device with one-dimension of movement.

2. Related Art

Digital Light Processing (DLP) has several advantages, including high brightness, accurate tone reproduction, fast response time, noise-free operation, and thin and light composition. Therefore, the DLP is one of the most potential projection technologies recently.

In a DLP projector, a digital control method and a light reflection principle are adopted. First, light rays are integrated or converged by a light integration rod and then pass through the color filter of the color wheel, which splits the light rays. The split light rays are then projected onto a digital micro-mirror device (DMD). In this technology, the DMD is used to replace the liquid crystal panel for representing images in the conventional liquid crystal projector. Since the DMD includes several movable micro-mirrors, driving electrodes may control the tilt angle and deflection time of each movable mirror. Then, the light rays may be projected to form an image by switching the reflection directions of the light rays.

As shown in FIG. 1, the DLP is provided with a color wheel 2 for generating different color light rays. The color wheel 2 mainly includes a cap 21, a color filter 22 and a motor 23. The cap 21 and the color filter 22 are fixed on the motor 23. Herein, the color filter 22 is a plate-shaped filter and can splits the light rays into red light rays, green light rays and blue light rays. The red light rays, blue light rays and green light rays may be projected to form the full color image in a projection system. The conventional color filter 22 may be a glass plate, on which at least a red film, at least a green film, and at least a blue film are formed. The shape, size and color disposition of the color filter 22 may be adjustable by the function of the color filter 22. For example, as shown in FIG. 1, red color, blue color and green color are disposed as the spiral pattern for increasing the output brightness of the full color image and increasing the saturation rate of the color.

As mentioned above, the conventional manufacturing method of the color filter 22 includes the steps of: forming the filter pattern on the glass plate by exposing and developing; then, cutting the glass plate to become a circular color filter 22; and then assembling the color filter 22 on the motor 23. However, it is necessary to form the spiral pattern color filter by several complicated manufacturing processes. Moreover, because the color filter is the circular color filter, the utility rate of the glass plate is quite low. Further, when the circular color filter 22 is assembled on the motor 23 of the color wheel 2, the center-of-gravity position of the color filter 22 may be easily displaced. In general, the motor 23 for the color wheel 2 rotates at a speed higher than 7200 rpm. Hence, when the rotation center of the color filter 22 is away from the central axis of the rotation shaft, the color wheel 2 may produce vibration and noise easily. Also, the reliability of the product may be decreased.

It is therefore an important subjective of the invention to provide a light-splitting device, which can solve the problems which are described above.

### SUMMARY OF THE INVENTION

In view of the foregoing, the invention is to provide a light-splitting device, in which a filter element with one-dimension of movement can be made by the simple manufacture process and the easy assembly process.

To achieve the above, a light-splitting device with one-dimension of movement of the invention is disposed on a casing. The light-splitting device includes a bearing element, a filter element and a power module. In this case, the bearing element is slidably disposed on the casing. The filter element is a color filter having a plurality of colors. The filter element is disposed on the bearing element. The power module is connected to the bearing element. The power module drives the bearing element to move in one dimension.

As mentioned above, in the light-splitting device with one-dimension of movement of the invention, the power module drives the bearing element to move in one dimension, and the bearing element makes a reciprocating motion in a straight line. Herein, the filter element can be in the form of a quadrangular sheet or a rectangular parallelepiped. The filter element has a plurality of color sections, and the disposition of the color sections may be adjustable by the real needs. For example, the filter element has different color sections, which are in the form of array and the filter element moves in one dimension in order to have the same splitting function of the conventional spiral color filter. Comparing to the prior art, because the filter element is not the conventional spiral color filter, the complicated manufacture process can be avoided. Hence, the good yield of the product can be increased. Furthermore, the filter element is not limited to the circular color filter, so that the utility rate of the glass plate can be increased. And, the displacement of the center-of-gravity position of the filter element can be solved.

### BRIEF DESCRIPTION OF THE DRAWINGS

The invention will become more fully understood from the detailed description given herein below illustration only, and thus is not limitative of the present invention, and wherein:

FIG. 1 is a schematic view showing the conventional color wheel;

FIG. 2 is a schematic view showing a light-splitting device according to a preferred embodiment of the invention;

FIG. 3 to FIG. 6 are a set of schematic views showing other light-splitting devices according to the preferred embodiment of the invention; and

FIG. 7 is a schematic view showing the movement of the light-splitting device according to the preferred embodiment of the invention.

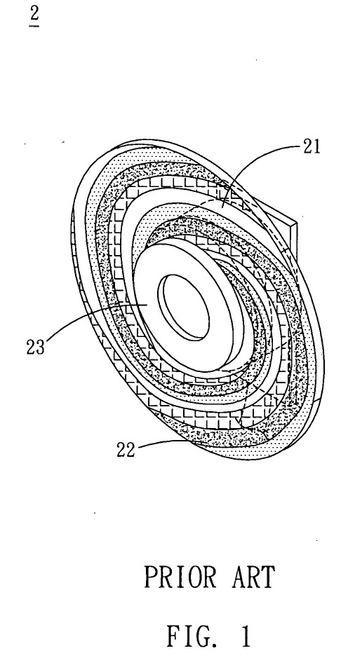

### DETAILED DESCRIPTION OF THE INVENTION

The present invention will be apparent from the following detailed description, which proceeds with reference to the accompanying drawings, wherein the same references relate to the same elements.

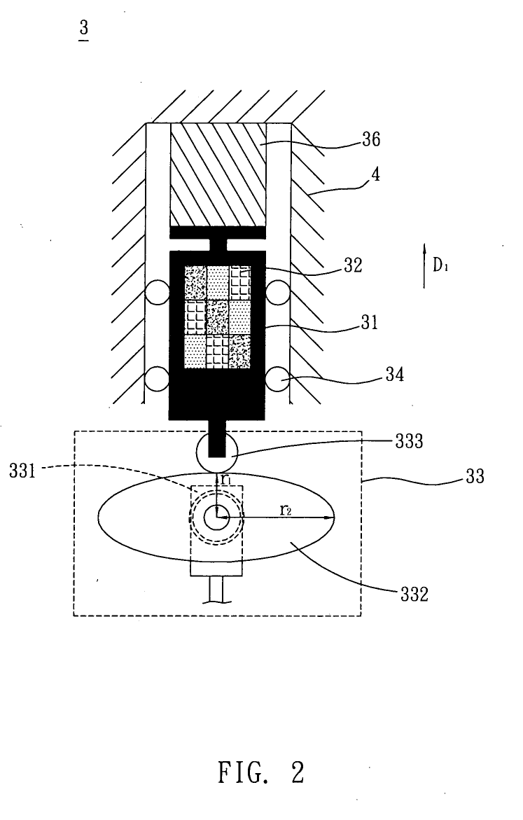

With reference to FIG. 2, a light-splitting device 3 according to a preferred embodiment of the invention is disposed on a casing 4. The light-splitting device 3 includes a bearing element 31, a filter element 32 and a power module 33.

In the current embodiment, the bearing element 31 is slidably disposed on the casing 4. The filter element 32 is a color filter having a plurality of color sections. Herein, the filter element 32 is disposed on the bearing element 31. In the current embodiment, the filter element 32 may be in the form of a quadrangular sheet or a rectangular parallelepiped. The filter element 32 has a plurality of color sections, and the disposition of the color sections may be adjustable by the real needs. As shown in FIG. 2, the filter element 32 has different color sections, which are in the form of array.

In the current embodiment, the power module 33 is connected to the bearing element 31. The power module 33 drives the bearing element 31 to move in one dimension. That is to say, the power module 33 drives the bearing element 31 to make a reciprocating motion in a straight line.

In the current embodiment, the light-splitting device 3 according to the preferred embodiment of the invention further includes a plurality of rolling elements 34. As shown in FIG. 2, four rolling elements 34 are disposed between the bearing element 31 and the casing 4, so that the bearing element 31 is slidably disposed on the casing 4 by the rolling elements 34.

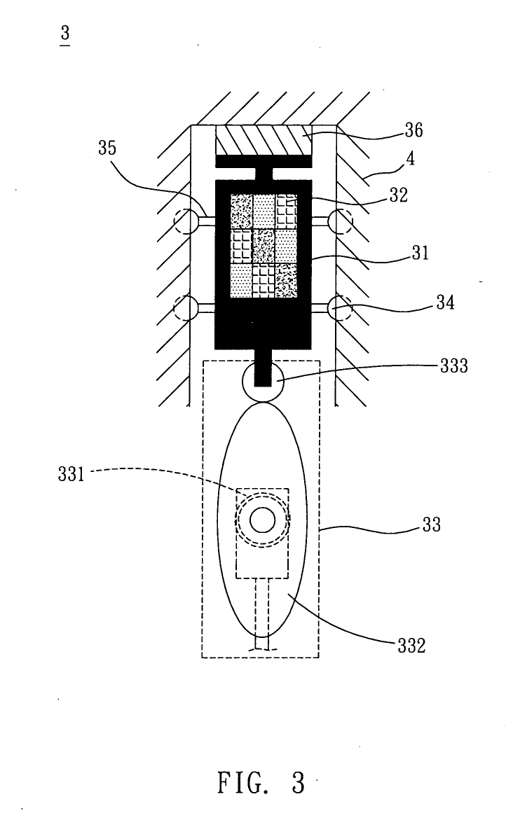

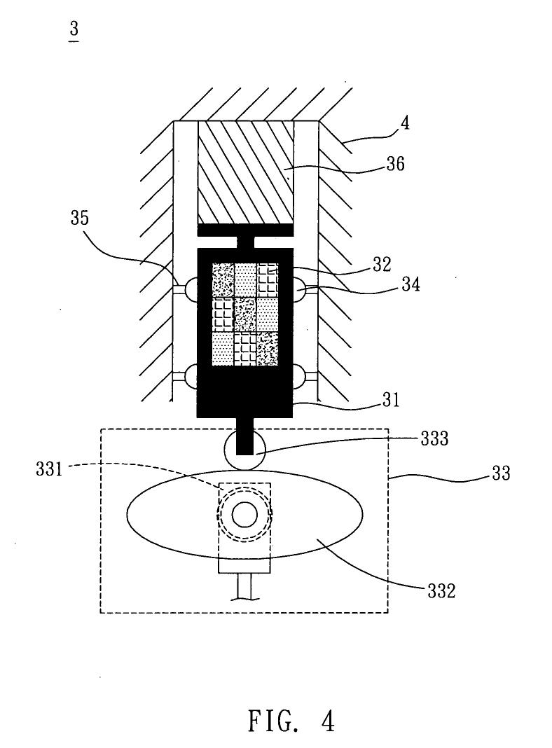

Please refer to FIG. 3, as mentioned above, one end of the rolling element 34 may also be disposed on the bearing element 31 by a connection element 35. Further, the casing 4 may also have a groove, and the rolling element 34 can be disposed in the groove. Hence, the bearing element 31 can be slidably disposed on the casing 4 by the rolling element 34. Besides, as shown in FIG. 4, one end of the rolling element 34 may also be disposed on the casing 4 by the connection element 35. Further, two sides of the bearing element 31 may have grooves, and the rolling element 34 can be disposed in the grooves, so that the bearing element 31 can be slidably disposed in the casing 4.

As shown in FIG. 2, the power module 33 has a motor 331, an active element 332 and a driven element 333. Herein, the active element 332 is pivoted on the motor 331, and the active element 332 is rotatble about a rotating shaft of the motor 331. The active element 332 contacts with the driven element 333, and the driven element 333 connects to the bearing element 31. In the current embodiment, the active element 332 may be in the form of an ellipse. The distance between the rotating shaft and each point on the edge of the active element is not constant.

In the current embodiment, the motor 331 of the power module 33 drives the active element 332, and the active element 332 brings the driven element 333, so that the bearing element 31 moves in one dimension.

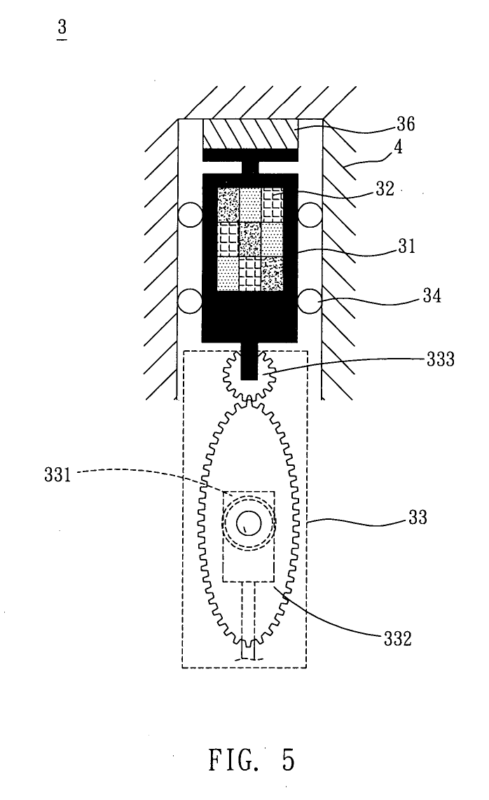

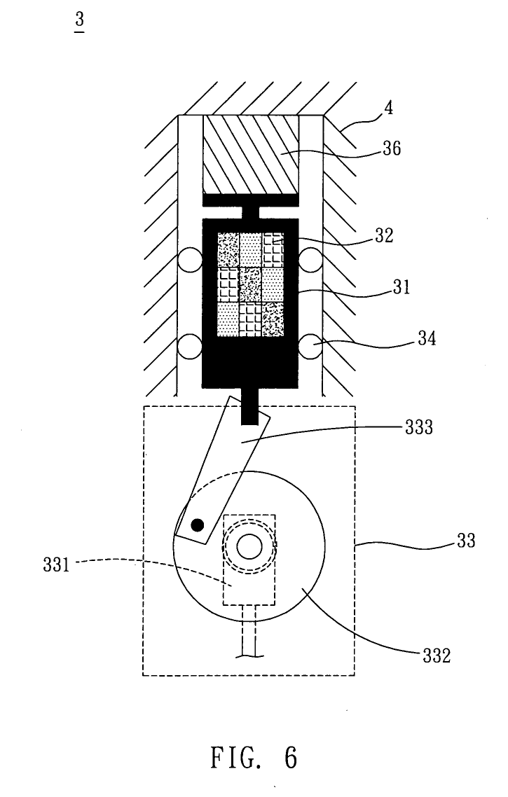

In the current embodiment, as shown in FIG. 2, the active element 332 may be a cam. Herein, the driven element 333 may be machine parts driven by the cam. Besides, as shown in FIG. 5, the active element 332 may also be a first gear. Herein, the driven element 333 may be a second gear. The first gear and the second gear are in mesh. Furthermore, as shown in FIG. 6, the active element 332 may be a plate-shaped body or a curved arm. Herein, the driven element 333 may be a curved arm driven by the active element 332.

Moreover, the light-splitting device 3 according to the preferred embodiment of the invention further includes a buffer element 36. One end of the buffer element 36 is fixed on the casing 4, and the other end of the buffer element 36 is connected to the bearing element 31, so that the bearing element 31 may make a reciprocating motion in a straight line. In the current embodiment, the buffer element 36 may be a spring, an vapor pressure piston or an oil pressure piston and so on.

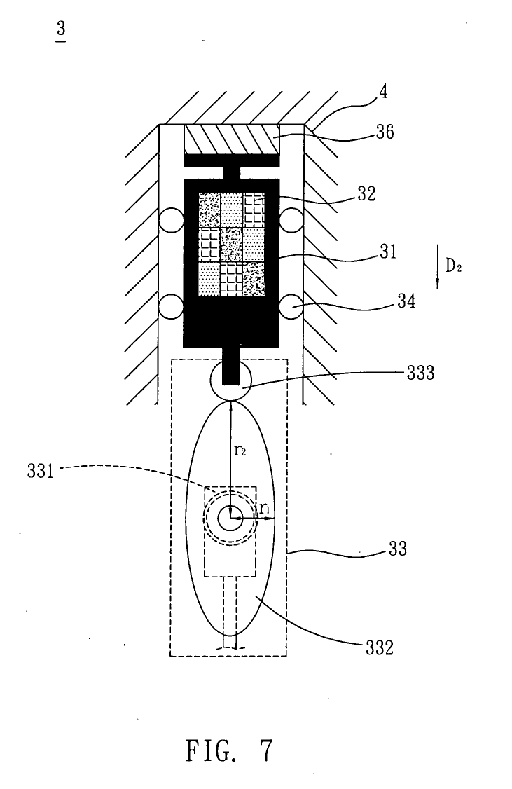

Please refer to FIG. 2 and FIG. 7, for easily understanding the movement of the light-splitting device according to the preferred embodiment of the invention, an example is described below.

Please refer to FIG. 2 and FIG. 7, the distance between the rotating shaft and each point on the edge of the active element is not constant and varies gradually. The motor 331 of the power module 33 drives the rotation of the active element 332, and the active element 332 drives the driven element 333, so that the bearing element 31 make a reciprocating motion in a straight line. As shown in FIG. 2 and FIG. 7, the distance r₁ is shorter than the distance r₂. When the motor 331 drives the active element 332 to rotate from a first position (as shown in FIG. 2) to a second position (as shown in FIG. 7), the displacement of the driven element 333 is increased gradually. Hence, the bearing element 31 moves in a first direction D₁.

On the other hand, as shown in FIG. 2 and FIG. 7, when the motor 331 drives the active element 332 to rotate from the second position (as shown in FIG. 7) to a third position which is opposite to the first position, the displacement of the driven element 333 is decreased gradually. At the same time, the buffer element 36 disposed between the casing 4 and the bearing 31 provides a retrieve force, so that the bearing element 331 moves in a second direction D₂. Herein, the first direction D₁ is opposite to the second direction D₂. In the current embodiment, the shape of the active element 332 may be adjustable by the real needs.

Because of the above, the motor 331 of the power module 33 drives the rotation of the active element 332, and the bearing element 331 moves in one dimension, so that the filter element 32 disposed on the bearing element 31 can split light rays.

As mentioned above, in the light-splitting device with one-dimension of movement of the invention, the power module drives the bearing element to move in one dimension, and the bearing element makes a reciprocating motion in a straight line. Herein, the filter element can be in the form of a quadrangular sheet or a rectangular parallelepiped. The filter element has a plurality of color sections, and the disposition of the color sections may be adjustable by the real needs. For example, the filter element has different color sections, which are in the form of array and the filter element moves in one dimension in order to have the same splitting function of the conventional spiral color filter. Comparing to the prior art, because the filter element is not the conventional spiral color filter, the complicated manufacture process can be avoided. Hence, the good yield of the product can be increased. Furthermore, the filter element is not limited to the circular color filter, so that the utility rate of the glass plate can be increased. And, the displacement of the center-of-gravity position of the filter element can be solved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light-splitting device with one-dimension of movement disposed on a casing, comprising:
a bearing element, which is slidably disposed on the casing;
a filter element, which is a color filter having a plurality of color sections, wherein the filter element is disposed on the bearing element; and
a power module, which is connected to the bearing element, wherein the power module drives the bearing element to move in one dimension.

2. The light-splitting device of claim 1, wherein the filter element is in the form of a quadrangular sheet.

3. The light-splitting device of claim 1, wherein the filter element is in the form of a rectangular parallelepiped.

4. The light-splitting device of claim 1, wherein the filter element has different color sections which are in the form of array.

5. The light-splitting device of claim 1, wherein the bearing element makes a reciprocating motion in a straight line.

6. The light-splitting device of claim 1, further comprising:
a plurality of rolling elements, which are disposed between the bearing element and the casing, so that the bearing element is slidably disposed on the casing by the rolling element.

7. The light-splitting device of claim 6, wherein one end of the rolling element is disposed on the bearing element by a connection element.

8. The light-splitting device of claim 6, wherein one end of the rolling element is disposed on the casing by a connection element.

9. The light-splitting device of claim 1, wherein the power module has a motor, an active element and a driven element, the active element is pivoted on the motor, the active element contacts with the driven element, the driven element connects to the bearing element, the motor drives the active element and the active element brings the driven element, so that the bearing element moves in one dimension.

10. The light-splitting device of claim 9, wherein the active element is an oval plate.

11. The light-splitting device of claim 9, wherein the active element is a cam.

12. The light-splitting device of claim 9, wherein the active element is a first gear.

13. The light-splitting device of claim 12, wherein the driven element is a second gear.

14. The light-splitting device of claim 13, wherein the first gear and the second gear are in mesh.

15. The light-splitting device of claim 9, wherein the active element is plate-shaped.

16. The light-splitting device of claim 9, wherein the active element is a curved arm.

17. The light-splitting device of claim 15, wherein the driven element is a curved arm.

18. The light-splitting device of claim 16, wherein the driven element is a curved arm.

19. The light-splitting device of claim 1, further comprising:
a buffer element, one end of the buffer element is fixed on the casing, the other end of the buffer element is connected to the bearing element.

20. The light-splitting device of claim 19, wherein the buffer elemennt is a spring.

21. The light-splitting device of claim 19, wherein the buffer elemennt is an vapor pressure piston or an oil pressure piston.
